(19) United States
(12) Patent Application Publication
(10) Pub. No.: US 2026/0148129 A1
(43) Pub. Date: May 28, 2026

(54) Decentralized Authentication of Anti-Counterfeiting QR Codes Using Vision Transformer-Based Federated Learning

(71) Applicant: Lingnan University, Hong Kong (CN)

(72) Inventors: Sam Tak Wu KWONG, Hong Kong (CN); Zhongyuan GUO, Hong Kong (CN)

(21) Appl. No.: 18/961,631

(22) Filed: Nov. 27, 2024

(51) Int. Cl. G06N 20/00; G06V 20/00

(52) U.S. Cl. CPC G06N 20/00; G06V 20/95

(57) ABSTRACT

A privacy-preserving authentication method for anti-counterfeiting QR codes using Vision Transformer- (ViT-)based Federated Learning (FL) is provided. In the method, an individual client authenticates an anti-counterfeiting QR code as captured in an image presented to the individual client. A local machine-learning (ML) model of the individual client determines authenticity of the anti-counterfeiting QR code as captured in an image presented to the individual client. The local ML model is initialized as a pretrained ViT-based model, pretrained on the large-scale ImageNet dataset for processing an input image to determine authenticity of the anti-counterfeiting QR code as captured in the input image. The plurality of clients performs a cyclic weight transfer FL process to update respective local ML models of the plurality of clients according to instant pluralities of training data respectively owned by different clients in the plurality of clients while preserving training-data privacy among the different clients.

ABBREVIATIONS

| | |
|---|---|
| CDP | copy detection pattern |
| CLTP | circumferential local ternary pattern |
| CNN | convolutional neural network |
| CWT | cyclic weight transfer |
| DMFNet | dual-branch multi-scale feature fusion network |
| FedAVG | federated averaging |
| FG-DPANet | feature-guided double pool attention network |
| FL | federated learning |
| ML | machine learning |
| MLP | multiple-layer perception |
| PUF | physical unclonable function |
| QR | quick response |
| SA | self-attention |
| SGD | stochastic gradient descent |
| TACA | triple anti-counterfeiting authentication |
| ViT | Vision Transformer |

### TECHNICAL FIELD

The present disclosure relates to a ML technique using a ViT-based model and FL for authenticating, by an individual client in a plurality of clients, an anti-counterfeiting QR code as captured in an image presented to the individual client.

### BACKGROUND

In recent years, as the core sensing technology of the Internet of Things and an import information portal of the Internet, QR codes are widely used in product information tracing and anti-counterfeiting [1]. The principle of QR code anti-counterfeiting traceability is to generate a unique QR label for each product, and to establish a reliable anti-counterfeiting mark. Existing QR code product authentication systems rely on serial numbers. That is, the user scans the QR code with a smartphone and decodes it to obtain the serial number information, and then initiates an authentication request. The authentication system returns the authentication result based on the serial number [2]. However, the aforementioned authentication scheme is susceptible to illegal copying attacks, where illegal copying is usually achieved by scanning and printing authentic QR codes [3].

To enhance the security and anti-counterfeiting capabilities of QR codes, researchers have developed various types of anticopying QR codes by integrating them with additional anti-counterfeiting measures. These measures include digital watermarking [4-6], halftone encryption [7-9], PUF [10-12], CDP [13, 14], and anti-counterfeiting patterns [15-19]. These anticopying QR codes are designed in such a way that any copying attempts result in distortions of the patterns or alterations in detailed features, making it possible to propose corresponding authentication methods to achieve anti-counterfeiting. Among these methods, the anti-counterfeiting pattern stands out due to its random distribution of fine textures. This pattern can be directly embedded into the QR code during printing, offering benefits such as low cost, high replication sensitivity, and extreme difficulty in forgery. Given its increasing attention, the present disclosure focuses on anti-counterfeiting QR codes embedded with anti-counterfeiting patterns. An example of anti-counterfeiting QR code is illustrated in FIG. 1, which depicts an anti-counterfeiting QR code 100 formed with a normal data-carrying region 110, and a copy-resistant pattern 120 located at the central part of the QR code 100.

A variety of detection methods have been proposed to effectively capture forged features in illegal copying, including spectral and spatial channel models [20], Gaussian models based on channel noise characteristics, CLTP [16], TACA [21], DMFNet [22] and FG-DPANet [17]. These detection approaches can be categorized into two primary strategies: manual feature extraction and deep learning methods.

Manual feature extraction, grounded in expert experience, involves theoretical analysis and rigorous modeling, providing high interpretability. However, this approach is often complex and time-consuming due to the extensive experimentation and validation required [23]. Deep learning methods represented by CNNs are able to automatically learn the representations of forged features in a data-driven manner, and have become one of the most popular approaches in most computer vision tasks due to their highly competitive performance compared to manual feature extraction [24]. These methods typically involve centralized training and testing by aggregating QR code data from multiple mobile clients on a central server [2, 3, 15], making them the dominant approach for forgery detection. However, the growing stringency of privacy protection legislation and increasing concerns over data privacy present unprecedented challenges to traditional centralized training paradigms [25, 26]. Due to fears of data breaches, consumers are reluctant to transmit and share local private data, rendering the centralized mode of data collection, storage, and processing increasingly unsustainable.

To summarize, the above-mentioned methods [2, 3, 15-17, 20-26] are all operated in a centralized authentication mode. That is, data need to be uploaded to a central server for processing and authentication. There is a need in the art for a decentralized authentication technique for authenticating anti-counterfeiting QR codes.

### SUMMARY

An aspect of the present disclosure is to provide a method for authenticating, by an individual client in a plurality of clients, an anti-counterfeiting QR code as captured in an image presented to the individual client. The method achieves decentralized, privacy-preserving authentication of the anti-counterfeiting QR code.

In the method, the individual client uses a local ML model of the individual client to determine authenticity of the anti-counterfeiting QR code as captured in the image when the image is presented to the individual client. The local ML model of the individual client is initialized as a local copy of a ML model shared by the plurality of clients. The ML model is a ViT-based model pretrained for processing an input image to determine authenticity of the anti-counterfeiting QR code as captured in the input image. Furthermore, the plurality of clients performs a CWT FL process to update respective local ML models of the plurality of clients according to instant pluralities of training data respectively owned by different clients in the plurality of clients while preserving training-data privacy among the different clients.

In certain embodiments, the CWT FL process comprises: ordering the plurality of clients to yield an ordered list of clients; and forming an expanded ordered list of clients by repeating the ordered list of clients for a predetermined number of times. The CWT FL process further comprises repeating a subprocess of fine-tuning the local ML model of a currently-selected client until a predetermined convergence condition of respective local ML models of the plurality of clients is met or until respective clients sequentially arranged according to the expanded ordered list of clients have been used as the currently-selected client in running the subprocess. The subprocess comprises: fine-tuning the local ML model of the currently-selected client with a corresponding instant plurality of training data owned by the currently-selected client; identifying a next client from the expanded ordered list of clients such that the next client becomes the currently-selected client in a next execution of the subprocess; and if the next client is identifiable, then after the local ML model of the currently-selected client is fine-tuned, replacing the local ML model of the next client with the local ML model of the currently-selected client such that the corresponding instant plurality of training data owned by the currently-selected client is utilized to update the local ML model of the next client but is not revealed to the next client. Additionally, the CWT FL process further comprises updating the respective local ML models of the plurality of clients with the local ML model of the currently-selected client used in a last execution of the subprocess.

In certain embodiments, the ML model includes first and second pluralities of model parameters for configuring the ML model, causing the local ML model of the individual client to be configured by corresponding first and second pluralities of model parameters of the individual client. The corresponding first plurality of model parameters of the individual client is fixed during executing the CWT FL process while the corresponding second plurality of model parameters of the individual client is adjustable for fine-tuning the local ML model of the individual client in the CWT FL process. Advantageously, the replacing of the local ML model of the next client with the local ML model of the currently-selected client in executing the subprocess includes overwriting the corresponding second plurality of model parameters in the local ML model of the next client with the corresponding second plurality of model parameters in the local ML model of the currently-selected client so as to replace the local ML model of the next client with the local ML model of the currently-selected client.

In certain embodiments, the first plurality of model parameters configures the ML model to identify edges and shapes of the anti-counterfeiting QR code.

In certain embodiments, a corresponding instant plurality of training data owned by the individual client is generated according to authentication results obtained form using the local ML model of the individual client to authenticate QR-code images received by the individual client.

In certain embodiments, the CWT FL process is repeated from time to time for regularly updating the respective local ML models.

In certain embodiments, the ViT-based model is selected to be a ViT(S) model.

In certain embodiments, the ML model is stored in a server that serves the plurality of clients. The CWT FL process further comprises updating the ML model with the local ML model of the currently-selected client used in the last execution of the subprocess to thereby allow the server to initialize a new local ML model of a new client with the updated ML model when the server adds the new client to the plurality of clients.

Other aspects of the present disclosure are disclosed as illustrated by the embodiments hereinafter.

### BRIEF DESCRIPTION OF THE DRAWINGS

FIG. 1 depicts an example of an anti-counterfeiting QR code embedded with a copy-resistant pattern.

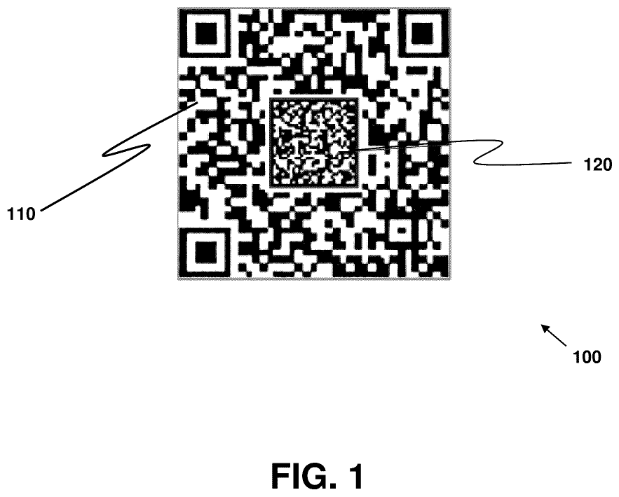

FIG. 2 depicts a ViT for authentication of anti-counterfeiting QR codes.

FIG. 3 depicts a pre-trained ViT model for anti-counterfeiting QR code authentication in accordance with an exemplary embodiment of the present disclosure.

FIG. 4 depicts a schematic diagram illustrating ViT-based FL for anti-counterfeiting QR code authentication.

FIG. 5 illustrates the impact of communication rounds on the performance of various models under the FedAVG algorithm.

FIG. 6 illustrates the impact of communication rounds on the performance of various models under the CWT FL algorithm.

FIG. 7 depicts a flowchart showing exemplary steps of a method as disclosed herein for authenticating, by an individual client in a plurality of clients, an anti-counterfeiting QR code as captured in an image presented to the individual client.

FIG. 8 depicts a flowchart for realizing certain embodiments of a CWT FL process used in the disclosed method.

Skilled artisans will appreciate that elements in the figures are illustrated for simplicity and clarity and have not necessarily been depicted to scale.

### DETAILED DESCRIPTION

As used herein, “anti-counterfeiting QR code” or “anticopying QR code” means a QR code including one or more anti-counterfeiting features, where an individual anti-counterfeiting feature is configured to, in a copy attempt of the QR code, generate distortion of at least one pattern on the QR code or alter the individual anti-counterfeiting feature.

As used herein, “client” means a computing device having a role of a client in accordance with a client-server architecture commonly known in computer science. Examples of the aforesaid computing device include a general-purpose computer, a desktop computer, a notebook computer, a mobile computing device, a smartphone, a tablet, etc. The aforesaid computer may be implemented with a camera or an imaging device for capturing images.

Disclosed herein is a systematic decentralized approach for authenticating anti-counterfeiting QR codes. After the decentralized approach is proposed and detailed, embodiments of the present disclosure will be elaborated based on disclosed details, examples, applications, etc. of the decentralized approach.

### I. Proposed Decentralized Approach

As an emerging research paradigm, FL [27, 28] can train models on local data distributed across multiple mobile devices. Specifically, each client uses its local data set to independently train the model, and then shares the model parameters with other participants. The actual data remains local, ensuring personal data privacy and mitigating the risk of data leakage, making it suitable for anti-counterfeiting QR code authentication using mobile devices. However, due to the different environmental disturbances and noises faced by multiple smart devices, it is difficult for CNN models to achieve satisfactory authentication performance on multiple devices at the same time. How to achieve decentralized high accuracy authentication while protecting user privacy is a challenge that needs to be solved urgently.

Recent research work has shown that ViT exhibits better generalization and robustness than CNNs on image classification tasks [29-32], which is attributed to the self-attention-like architectures. Inspired by the above-mentioned studies, the Inventors innovatively introduce ViT into anti-counterfeiting QR code authentication to improve the performance of authentication models deployed on different smart devices.

Accordingly, the present disclosure proposes a privacy-preserving authentication scheme for anti-counterfeiting QR codes based on ViT and FL. Privacy preserving refers to the practice of ensuring that ML models do not disclose any confidential information about data owners during training or inference. It is worth noting that the proposed scheme belongs to the block-based forgery detection method [24]. That is, the anti-counterfeiting QR code image is firstly divided into non-overlapping square blocks, which can effectively highlight the subtle feature differences in pattern distortion between the genuine and counterfeit QR codes, and avoid the interference caused by the image content. The QR code data are distributed on each user's mobile device and the amount of data per client is small. Thus, pretrained models on the large dataset ImageNet-1k [33, 34] for transfer learning are introduced. These pre-trained models are proved to have good generalization ability. The initial and intermediate layers, which identify edges and shapes, can be utilized without modification, while only the final layers are adjusted to adapt to the task of authenticating anti-counterfeiting QR codes. In the FL framework, individual smartphones finetune respective pre-trained models with local data and then share the model parameters with other participants. However, different smartphones face different lighting environments, camera fingerprint noise, and blurring jitter. In order to build an authentication model that can better adapt to individual mobile devices, the Inventors innovatively introduce a CWT FL algorithm, where the weights are transferred and updated in a cyclic manner across individual clients to better capture and integrate the unique data distribution features on each client, thus improving the authentication model's generalization ability on data from different clients. To the best of the Inventors' knowledge, there has been no publicly available dataset in the field of QR code authentication research. Therefore, the Inventors built a self-constructed dataset using nine printers and eight smartphones for experiments. The experimental results show that, when compared with the traditional state-of-the art centralized authentication scheme based on CNNs, the proposed approach shows a competitive performance while protecting data privacy.

In what follows, details of the proposed approach will be elaborated. First, the pre-trained vision transformer model for anti-counterfeiting QR code authentication will be introduced. Then the serial FL framework and CWT FL, which can effectively protect personal privacy data, will be described. Finally, the proposed decentralized authentication scheme combining the above strategies will be detailed.

### A. Pre-Trained ViT for Anti-Counterfeiting QR Code Authentication

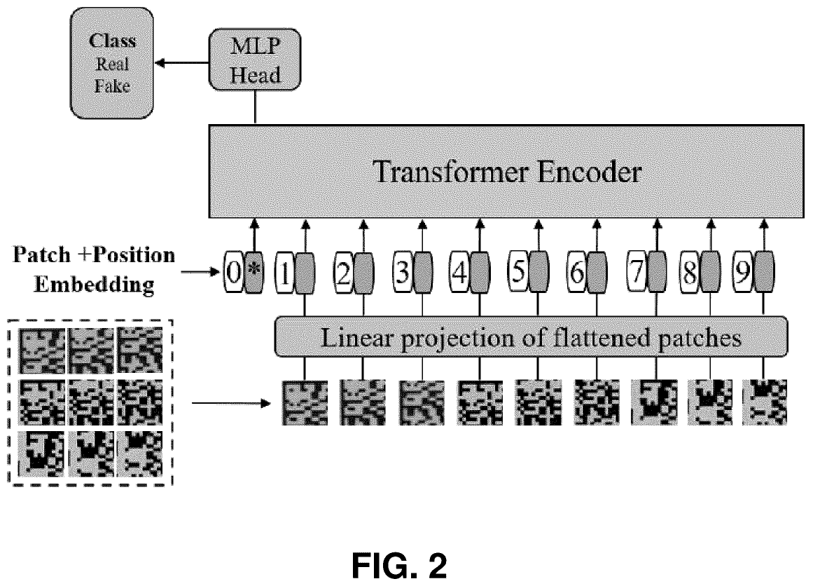

The Transformer architecture was first applied in the field of machine translation, followed by advanced performance in natural language processing tasks [39]. As research continues, Transformers have also been found to be suitable for applications in image and video tasks, showing promising results. Dosovitskiy et al. [40] attempted to directly apply Transformer with global attention to computer vision tasks and proposed ViT, which outperformed CNNs on diverse computer vision tasks. FIG. 2 depicts a block-diagram structure of the ViT.

ViT first divides each image evenly into n blocks, and divides each block evenly into token embeddings xᵢ∈ [symbol] , i=1, 2, . . . , n. Then, all these tokens are fed into a stack of transformer blocks. Each transformer block leverages SA to perform token mixing, and uses MLP to perform channel-wise feature transformation. SA is used to aggregate global information, the input token embedding tensor can be represented as X=[x₁, x₂, . . . , xₙ]∈ [symbol] , and the linear transformation is applied to parameters W_{K}, W_{Q}, and W_{V} respectively, where

$$K = {W}_{K} X ∈ , \qquad ( 1 )$$

$$Q = {W}_{Q} X ∈ \qquad ( 2 )$$

$$V = {W}_{V} X ∈ \qquad ( 3 )$$

Then a SA module computes the attention matrix and aggregates the token features as follows:

$${Z}^{T} = SA ( X ) = Softmax ( \frac{{Q}^{T} K}{\sqrt{d}} ) {V}^{T} {W}_{L} \qquad ( 4 )$$

where W_{L}∈ [symbol] is linear transformation, X=[z, z₂, . . . , zₙ] is the aggregated token features, and d is a scaling factor. The output of the SA is then normalized and fed into the MLP to generate the input to the next block. The MLP consists of two linear layers and a GELU layer, which converts input tokens into features Z:

$${Z}^{′} = MLP ( Z ) . \qquad ( 5 )$$

In the authentication task under the smartphone capture scenario, the quality of the captured QR code image directly affects the accuracy and reliability of the authentication results. Due to the effects of camera jitter and environmental noise, the captured QR code images are degraded and distorted, affecting the quality of the QR codes. Thus, it is necessary to establish a robust authentication model for the above situations.

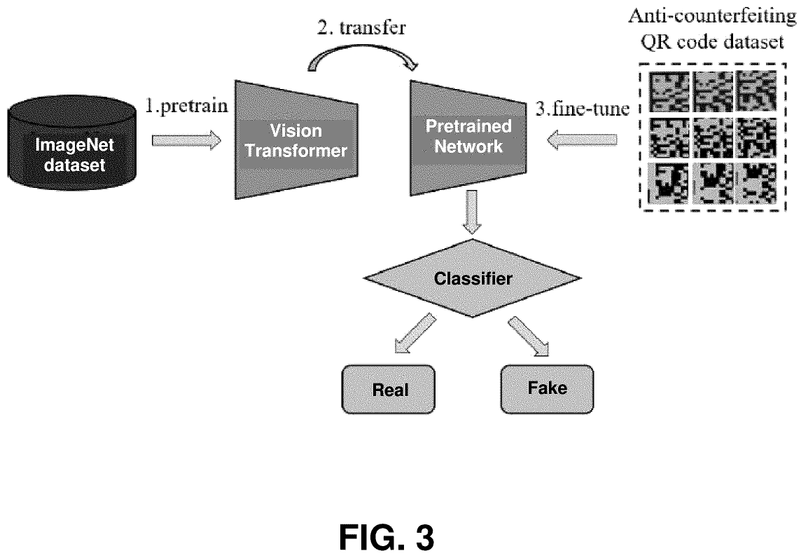

Recent studies have found that ViT is highly robust to severe occlusions, perturbations, and domain shifts [41]. Inspired by the aforementioned findings, the present disclosure introduces ViT to the authentication of QR codes. As far as the Inventors know, the present disclosure is the first attempt of ViT in research on authenticity identification of QR codes. Compared to CNNs, ViT can capture the global relationship among elements well and has greater representation ability. However, due to the lack of inductive bias of convolution, ViT needs to rely on a large number of training samples to fully learn local features, the requirement for data volume is higher. In order to reduce the demand for data volume, the present disclosure introduces the ViT model pretrained on the large ImageNet-1K dataset, and the ViT model is migrated to the anti-counterfeiting QR code authenticity identification task. FIG. 3 depicts a schematic diagram showing a whole exemplary process of identifying authenticity of the anti-counterfeiting QR code.

### B. Supervised Federated Fine-Tuning

FL [42, 43] is a distributed ML paradigm with promising applications, which is characterized by the fact that each client trains a model independently using local data, and then shares the model parameters with other participants, thus protecting data privacy. Compared to the traditional centralized learning methods, FL reduces the risks of data transmission and privacy leakage, and improves the scalability and adaptability of models. Widely used FL algorithms include FedAVG, CWT, etc.

FedAVG [44] is a foundational algorithm in FL that aggregates locally computed model updates from multiple client devices to form a global model. Each client trains its model on local data, and the server averages these model updates to improve the global model iteratively. This process preserves data privacy by keeping data decentralized while enabling collaborative model training.

CWT [45] is a typical serial FL method, the local client is trained in a serial and cyclic manner. In each training round, CWT uses local data to train a global model on one local client for one or more cycles, and then this global model is transferred to the next client for training until all local clients have been trained once. The training process is repeatedly cycled between clients until the model converges or a predefined number of communication rounds is reached.

Due to the multi-round cyclic transmission mechanism of CWT, the models of individual participants integrate the data characteristics from different participants. Thus, it can better capture the global data distribution than FedAVG. In addition, the model of each participant is updated by the parameters of multiple other participants, which can reduce the impact of a single participant on the global model and improve the robustness of the overall model. The present disclosure innovatively deploys a pre-trained vision transformer model in the two typical FL algorithms mentioned above, and then applies it to the authenticity identification of QR codes through fine-tuning, thereby realizing a robust QR code authentication method with privacy protection characteristics.

### C. ViT-Based CWT FL for Anti-Counterfeiting QR Code Authentication

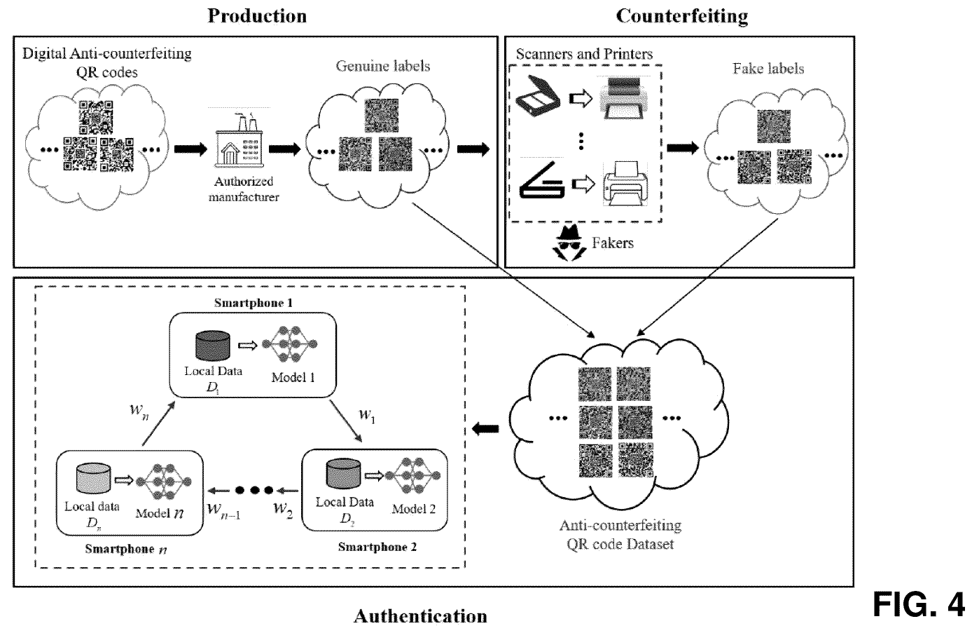

Most of existing authentication methods scan an anti-counterfeiting QR code and upload it to a global cloud server, use a database and an authentication model both stored in a server to make comparison and analysis to thereby obtain an authentication result, and then feedback the authentication result to the user. This arrangement is centralized authentication with a risk of privacy leakage. In fact, users are unwilling to share the private anti-counterfeiting QR code data for fear of data leakage, and the data usually exists in the form of silos in multiple users, which makes it difficult to converge into a large amount of data. Different from the previous centralized authentication method, the present disclosure defines QR code authentication as distributed authentication for smartphones. This setting is more in line with the objective fact that the QR code is authenticated by each user's smartphone, as shown in FIG. 4.

Due to differences among data of QR codes forged by different printing devices, and different brands and models of smartphones used by different users, a direct use of FL to aggregate model parameters from multiple users is likely to lead to poor authentication results, while the direct models of users using local data for training are unable to establish an effective identification model due to the small amount of known label data. Aiming at the aforementioned problems, the present disclosure proposes a federated transfer learning framework for QR code authentication. This framework uses parameter transfer strategy of CWT [28] to reduce the number of local model parameters and improve the security of parameter transfer. Ultimately, multiple users collaborate to build a shared model for transfer learning, and users use local data to fine-tune the shared model to realize QR code authentication.

The detailed procedures of the proposed method are shown in Algorithm 1. There are N local clients, and the local data set of each client is denoted as Dᵢ, i∈{1, 2, . . . , N}, and the local model of each client is denoted as [symbol] , i∈{1, 2, . . . , N}.

Algorithm 1: The ViT-CWT method.

| Input: Local client have N clients D = {D₁, D₂, ... , D_{N}}, the | |
|---|---|
| initial Pre-trained ViT Model is [symbol] , R is the number of total | |
| communication rounds for each client | |
| Output: Cyclically Updated ViT Model [symbol] after R rounds | |
| 1. | for r = 1 to R do |
| 2. | for each client Cᵢ ∈ D do |
| 3. | Train [symbol] on Dᵢ for the r-th round |
| 4. | Pass [symbol] to the next client Cᵢ₊₁ (or Cᵢ if i = N) |
| 5. | end for |
| 6. | end for |
| 7. | return Output |

### II. Experiments

In this section, experiments used to verify the proposed method are introduced. The experiments were conducted on a newly created dataset on which all presented methods were tested and evaluated. The effectiveness of the proposed method was validated through a series of comparative experiments, including comparisons with previous centralized training models, comparisons with different FL algorithms, ablation studies and anti-blur experiment.

### A. Dataset

At the time of doing the experiments, there was no publicly available dataset for research on decentralized authentication of anti-counterfeiting QR codes collected from multiple smartphones. Therefore, we built our self-constructed anti-counterfeiting QR code dataset for authentication.

1) Production and counterfeiting of anti-counterfeiting QR codes: First, eight anti-counterfeiting QR code types were used, with 100 of each type, including C5-D1-Ft2, C5-D1-Ft3, C5-D1.2-Ft2, C5-D1.3-Ft3, C6-D1-Ft2, C6-D1-Ft3, C6-D1.2-Ft2 and C6-D1.2-Ft3, where C represents the type of QR code, D represents the texture density of the anti-counterfeiting pattern, Ft represents the fault tolerance level. The purpose of this setting was to verify that our proposed method could be applied to various types of anti-counterfeiting codes. Next, the authorized printer, named Xerox DocuCentre color-C7500, was used to print the authentic anti-counterfeiting QR codes, so 800 authentic anti-counterfeiting QR codes were obtained. Then, illegal copying of anti-counterfeiting QR codes was implemented through scanners and illegal printers. Considering the diversity of potential scanners and printers in the counterfeiting process, three scanners were used, where Epson-WF-M21000a was used to scan C5-D1-Ft2, C5-D1-Ft3 and C5-D1.2-Ft2, and SHARP MX-5608N PCL6 was used to scan C5-D1.3-Ft3, C6-D1-Ft2 and C6-D1-Ft3, and Cannon 9000F mark2 was used to scan C6-D1.2-Ft2 and C6-D1.2-Ft3; eight illegal printers were engaged in counterfeiting, each illegal printer forged only one type of anti-counterfeiting QR codes. The correspondence between them is shown in Table I. As a result, 800 counterfeit anti-counterfeiting QR codes were obtained. Finally, all the authentic and fake anti-counterfeiting QR codes were captured by eight smartphones with different brands and models, which were also considered as clients. Information on the brands and models of these smartphones is shown in Table I. Each smartphone collected 100 authentic anti-counterfeiting QR codes and 100 counterfeit anti-counterfeiting QR codes, and obtained a total of 1600 anti-counterfeiting codes. The image sizes of all anti-counterfeiting QR codes were unified to 512×512.

TABLE I
The brand and model information of
printers, scanners and smartphones.

| Anti-counterfeiting | | |
|---|---|---|
| code type | Illegal printer | Smartphone |
| C5-D1-Ft2 | Knoica MINOLTA bizhub | iPhone 8 Plus |
| C5-D1-Ft3 | Aficio Mp 9001 | Huawei nova 6 |
| C5-D1.2-Ft2 | DocuCentre VC7785 | Huawei mate 40 Pro |
| C5-D1.2-Ft3 | Aficio Mp 9002 | Xiaomi 11 |
| C6-D1-Ft2 | RICHO Pro907Ex RPCs | Huawei nove5 Pro |
| C6-D1-Ft3 | Xerox DocuCentre color- | Oppo Reno 5 Pro |
| | C7500 | |
| C6-D1.2-Ft2 | Epson Wf-M2100a | iPhone XR |
| C6-D1.2-Ft3 | Aficio Mp 7001 | Redmi k30 |

After obtaining the data of genuine anti-counterfeiting QR codes and counterfeit anti-counterfeiting QR codes, we created an anti-counterfeiting QR code dataset for decentralized authentication using smartphones.

2) Anti-counterfeiting QR code dataset for decentralized authentication using smartphones: We randomly sampled 10 genuine and 10 counterfeit anti-counterfeiting codes from the data collected by each smartphone. A total of 80 genuine and 80 anti-counterfeiting codes were obtained from 8 smartphones, which were used as the validation set. Similarly, we performed the same sampling procedure to obtain the test set. Finally, 80 genuine and 80 counterfeit anti-counterfeiting codes remained for each smartphone, which served as the local training data for each client. In deep learning-based authentication of anti-counterfeiting QR codes, differences between genuine and counterfeit anti-counterfeiting codes are subtle. Interference caused by image content can be avoided effectively through the block-based pre-processing method, and the differences between categories can be amplified. Therefore, each anti-counterfeiting QR code is divided into 64 patches, and the size of each patch is 64×64. Consequently, the local training set of each client, validation set, and test set contain 5120 authentic anti-counterfeiting code patches and 5120 counterfeit anti-counterfeiting code patches, resulting in a total of 102,400 patches.

### B. Implementation Details

The proposed method was implemented on the PyTorch deep learning framework and our model was trained on NVIDIA Geforce RTX 4070 GPU platform with 12 GB memory. The local training batch size was set to 32, and SGD was used for optimization with an initial learning rate of 0.003. Since eight smartphones were used to collect data, we set eight diverse data centers as local clients. The number of local training epochs on each client was set to 1 and the total number of communication rounds to 100. For fair comparison, all pre-trained models were trained on ImageNet-1K [46]. Meanwhile, since the present disclosure focuses on decentralized authentication for smartphones, models with too many parameters and high complexity are not conducive to deployment in smartphones. Therefore, all models used for comparison were under 30 MB in model size.

C. Comparison with Previous Centralized Training Models

In this section, our proposed method is compared with state-of-the-art methods on self-constructed anti-counterfeiting QR code dataset, and we utilize the classification accuracy as the quantitative metric. As shown in Table II, we reimplemented several cutting-edge deep learning algorithms widely used in the field of image forensics, including ResNet18 [47], EfficientNet [48], and ViT [40]. For these algorithms we adopted two training strategies: fine-tuning the pre-trained models and training from scratch. We also compare the proposed method with representative CNNs specialized in QR code authentication, which are DMFNet [22] and FGDPANet [17]. DMFNet is a dual-branch multi-feature fusion network composed of residual blocks, and FG-DPANet is a feature-guided dual-pooling attention network embedded with attention modules. The above-mentioned methods achieve good authentication results using centralized training mode, but the drawback is that they cannot protect the privacy of training data in the QR code authentication task. Note that the proposed method belongs to the distributed training method, where the personal data is stored in the local client, which is different from the previous centralized training methods that do not consider the privacy issues.

TABLE II
Comparison with previous centralized training models.

| Method | Accuracy (%) |
|---|---|
| | Without Considering Privacy Issue |
| DMFNet [22] | 99.45 |
| FG-DPANet [17] | 99.46 |
| ResNet18 [47] | 99.90 |
| EfficientNet-b0 [48] | 99.98 |
| ViT(T) [49] | 99.79 |
| ViT(S) [50] | 99.81 |
| Pre-Trained ResNet18 | 99.98 |
| Pre-Trained EfficientNet-b0 | 100 |
| Pre-Trained ViT(T) | 99.98 |
| Pre-Trained ViT(S) | 100 |
| | Considering Privacy Issue |
| Pre-Trained ViT(S) + FedAVG | 99.95 |
| Pre-Trained ViT(S) + CWT | 100 |

As can be seen from Table II, when user privacy is not considered, the accuracy of ResNet18, EfficientNetb0, DMFNet, FG-DPANet, ViT(T), ViT(S) trained from scratch is 99.90%, 99.98%, 99.45%, 99.64%, 99.79% and 99.81%, respectively. On the other hand, the accuracy of ResNet18, EfficientNetb0, ViT(T) and ViT(S) fine-tuned using pre-trained models are 99.98%, 100%, 99.98% and 100%, respectively. The accuracy figures of the centralized models are all improved after using the finetuning approach of pre-trained models.

When considering user privacy protection, we adopted two FL algorithms: FedAVG and CWT. FedAVG trained each local client in parallel in a synchronous or asynchronous manner, while CWT trained each client in a serial and cyclic manner. Accuracy figures of the pre-trained ViT(S) model in the FedAVG and CWT FL framework are 99.95% and 100%, respectively. We found that the CWT training method in CWT has better performance on QR code authentication, which is due to the fact that CWT trains a global model on a local client with its local data, and then transfers this global model to the next client for training after each epoch, and so on and so forth until all local clients are trained. The training process is then repeated on the clients until the model converges or reaches a predefined number of communication rounds, which makes the training more adequate.

### D. Comparison of Different FL Algorithms

This study mainly applies two mainstream FL algorithms to achieve privacy protection, namely parallel FedAVG and serial CWT. This section compares these two algorithms. We implemented six mainstream deep learning models, ResNet18, ResNet34, EfficientNet-b0, EfficientNetb5, ViT(S) and ViT(T) under two FL frameworks. For these models we adopted two training strategies: training from scratch; and fine-tuning the pre-trained models.

TABLE III
Experiments with different federated learning frameworks.

| | | Accuracy (%) | |
|---|---|---|---|
| Training mode | Method | FedAVG | CWT |
| From scratch | ResNet18 | 88.17 ± 5.51 | 91.39 ± 4.63 |
| | ResNet34 | 91.02 ± 5.35 | 91.60 ± 4.05 |
| | EfficientNet-b0 | 91.86 ± 5.04 | 87.56 ± 3.91 |
| | EfficientNet-b5 | 91.71 ± 4.13 | 86.79 ± 4.77 |
| | ViT(T) | 96.30 ± 0.00 | 98.59 ± 0.01 |
| | ViT(S) | 97.74 ± 0.00 | 99.19 ± 0.01 |
| Pre-trained | ResNet18 | 96.33 ± 2.78 | 95.59 ± 1.77 |
| | ResNet34 | 95.73 ± 3.01 | 95.14 ± 2.40 |
| | EfficientNet-b0 | 95.29 ± 2.24 | 92.03 ± 5.83 |
| | EfficientNet-b5 | 95.39 ± 2.46 | 94.85 ± 2.44 |
| | ViT(T) | 99.87 ± 0.00 | 99.98 ± 0.01 |
| | ViT(S) | 99.95 ± 0.00 | 100.00 ± 0.00 |

As can be seen from Table III, first, by comparing different training strategies, the method of fine-tuning using pre-trained models yields better results than training from scratch on both the CNN-based models and ViT-based models. Then, comparing the different types of models, the ViT-based models can get better results than the CNN-based models, regardless of the training strategies used. Finally, comparing different FL algorithms, we find that for CNN-based models, we cannot determine which FL algorithm is better, but for ViT-based models, CWT has better performance that FedAVG, where the pre-trained ViT(S) model performs the best, and can obtain an accuracy of 100% under the CWT FL algorithms. Therefore, the pre-trained ViT(S) model under the CWT FL framework is used as the proposed method.

### E. Ablation Study

In this section, we conduct ablation comparison experiments of our proposed method, including different ViT model settings (ViT(S) and ViT(T)), different training mode settings (with and without Pre-trained), different FL framework setting (FedAVG and CWT).

TABLE IV
Ablation experiment of our proposed method.

| Setting | Accuracy (%) |
|---|---|
| ViT(T) + FedAVG | 96.35 |
| ViT(S) + FedAVG | 97.74 |
| ViT(T) + CWT | 98.59 |
| ViT(S) + CWT | 99.19 |
| Pre-trained ViT(T) + FedAVG | 99.87 |
| Pre-trained ViT(S) + FedAVG | 99.95 |
| Pre-trained ViT(T) + CWT | 99.98 |
| Pre-trained ViT(S) + CWT (Ours) | 100.00 |

As can be seen in Table IV, we have made various combinations of the three variable settings of ViT model selection, FL framework selection, and whether or not to perform pre-training, to determine the most suitable scheme for authentication of anti-counterfeiting QR codes. We found that when considering the choice of ViT model, keeping the settings of the other two variables the same, ViT(S) showed better performance than ViT(T). Similarly, CWT shows better performance than FedAVG, and Pre-trained mode shows better performance than the mode of training from scratch. The best performance is obtained when using the pre-trained ViT(S) model in the CWT FL framework, with an accuracy of 100%, therefore we identify it as the proposed scheme.

### F. Impact of Number of Communication Rounds on Performance of the Authentication Model

In this section, we mainly discuss the impact of the number of communication rounds on the performance of the authentication model. In the QR code authentication considering privacy protection, the setting of the number of communication rounds in FL is crucial. The rapid convergence of the authentication model can minimize the communication requirements and effectively reduce the training time.

We set the number of communication rounds to 100. When each round of training was completed, the current model was tested. After the overall training process was completed, we found out which models could converge faster and more stably while maintaining better authentication performance. The experiments were conducted under the two FL algorithms of FedAVG and CWT FL, models such as EfficientNet-b0, ResNet18, ViT(T) and ViT(S) were all taken into consideration, both fine-tuning pre-trained models and training from scratch strategies were adopted.

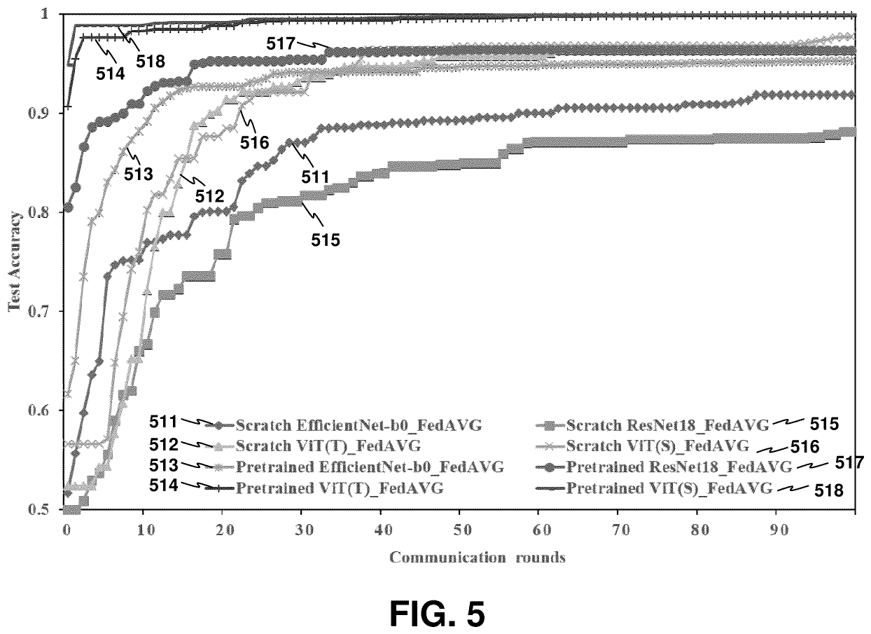

FIG. 5 shows the relationship between the number of communication rounds and test accuracy using the FedAVG FL algorithm. In FIG. 5, curve 511 plots results for a situation of training from scratch and using EfficientNet-b0; curve 512 plots results for a situation of training from scratch and using ViT(T); curve 513 plots results for using pre-trained EfficientNet-b0; curve 514 plots results for using pre-trained ViT(T); curve 515 plots results for a situation of training from scratch and using ResNet18; curve 516 plots results for a situation of training from scratch and using ViT(S); curve 517 plots results for a using pre-trained ResNet18; and curve 518 plots results for using pre-trained ViT(S). In the curves 511-518, the FedAVG FL algorithm is used.

From the perspective of training methods, fine-tuning the pre-trained model has better performance than training from scratch. From the comparison between the ViT models and the CNN models, the ViT models not only have more stable and faster convergence under the same training method, but also have better authentication performance. Specifically, the pre-trained ViT(S) model can converge faster and more stably, and has the best performance. This part of the experiment was mainly carried out using the pre-trained model under the CWT FL framework.

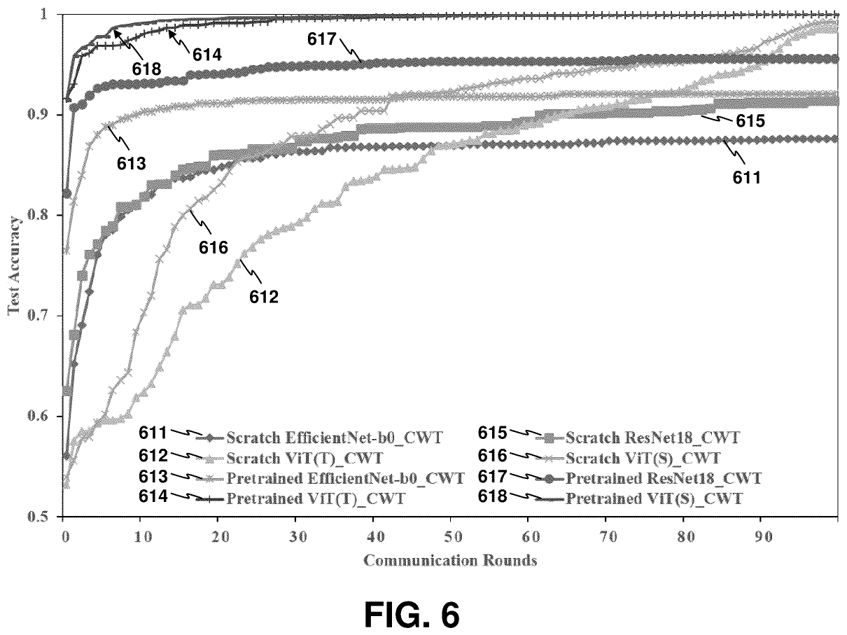

FIG. 6 shows the relationship between the communication rounds and the test accuracy using the CWT FL algorithm. In FIG. 6, curve 611 plots results for a situation of training from scratch and using EfficientNet-b0; curve 612 plots results for a situation of training from scratch and using ViT(T); curve 613 plots results for using pre-trained EfficientNet-b0; curve 614 plots results for using pre-trained ViT(T); curve 615 plots results for a situation of training from scratch and using ResNet18; curve 616 plots results for a situation of training from scratch and using ViT(S); curve 617 plots results for a using pre-trained ResNet18; and curve 618 plots results for using pre-trained ViT(S). In the curves 611-618, the CWT algorithm is used.

From the perspective of training methods, whether they are ViT models or CNN models, the use of pre-trained models for fine-tuning can achieve faster and more stably convergence than training from scratch. From the comparison between the ViTs and the CNNs, whether they were trained from scratch or pre-trained, when the communication rounds reaches 100, the ViT models have better performance than the CNN models. Specifically, the ViT(S) fine-tuned with the pre-trained model achieves the fastest and best convergence, and has the best performance in terms of authentication performance.

To summarize, comparing FIG. 5 and FIG. 6, we find that finetuning the pre-trained ViT(S) model on the CWT FL algorithm can reach convergence faster and better than the FedAVG FL algorithm, and combined with the ablation experiments analyzed in Table IV, the pretrained ViT(S) model has the highest accuracy among the CWT algorithms, which reaches 100%.

### G. Anti-Blur Experiments Under CWT Using Pre-Trained Models

In practical scenarios, due to the relative motion between the smartphone and the anti-counterfeiting QR code during the handheld shooting process, the image of the anti-counterfeiting QR code obtained from the shooting is prone to blurring, which affects the performance of the authentication method. Therefore, it is necessary to test the anti-blurring ability of the proposed method. We used OpenCV computer vision library to add different degrees of motion blur to all the QR code blocks in the test set in batches, and successively set the lengths of the motion blur kernel to 0, 2, 4, and 6, respectively, and the angle of blur kernel was set to 45 degrees. When the length of the blur kernel is 0, it represents the clear anti-counterfeiting QR code image without blur, and it is used as a reference value. Note that the experiments in the above two sections have proved that the pre-trained models present better performance than training from scratch in the authentication of anti-counterfeiting QR codes. Thus, we consider the pre-trained models in this section, and the models used for comparison in this section include ResNet18, EfficientNet-b0, ViT(S), and ViT(T). The FL framework used is CWT. The results of anti-blur experiments are shown in Table V.

TABLE V
Anti-blur experiment using pre-trained
models under CWT federated framework.

| | Motion-blur Kernel Size | | | |
|---|---|---|---|---|
| Method | 0 | 2 | 4 | 6 |
| Pre-trained ResNet18 | 95.59% | 94.12% | 93.22% | 89.72% |
| Pre-trained EfficientNet-b0 | 92.03% | 67.96% | 63.51% | 65.54% |
| Pre-trained ViT(T) | 99.98% | 97.48% | 96.20% | 94.10% |
| Pre-trained ViT(S) | 100% | 98.62% | 98.33% | 93.54% |

From Table V, it can be observed that the authentication performance of the four pre-trained models under the CWT FL framework exhibits a declining trend as the blur kernel length increases. Among these models, EfficientNetb0 suffers the most significant performance degradation, with its accuracy decreasing sharply from 92.03% to 67.96% as the blur kernel length increases from 0 to 2. In contrast, the ViT model shows superior resistance to blurring compared to CNN-based models. The pre-trained ViT(S) consistently achieves the best performance in most scenarios, maintaining an authentication accuracy of 98.33% even with a blur kernel length of 4, thereby confirming its advantage in authentication task under blurred conditions.

### III. Embodiments of Present Disclosure

Embodiments of the present disclosure are developed as follows based on the details, examples, applications, etc. regarding the decentralized approach for authenticating anti-counterfeiting QR codes as disclosed above, possibly with generalization.

An aspect of the present disclosure is to provide a method for authenticating, by an individual client in a plurality of clients, an anti-counterfeiting QR code as captured in an image presented to the individual client.

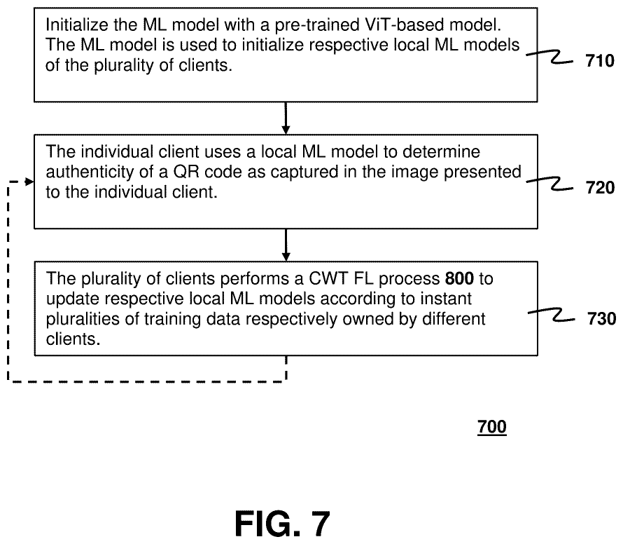

The method is illustrated with the aid of FIG. 7, which depicts a flowchart 700 showing exemplary steps of the disclosed method. Exemplarily, the method comprises steps 710, 720 and 730.

In the step 720, the individual client uses a local ML model of the individual client to determine authenticity of the anti-counterfeiting QR code as captured in the image when the image is presented to the individual client. The local ML model of the individual client is initialized in the step 710 as a local copy of a ML model shared by the plurality of clients. Advantageously, the ML model is a ViT-based model pretrained for processing an input image to determine authenticity of the anti-counterfeiting QR code as captured in the input image. The ViT-based model, such as the ViT proposed by [40], is a transformer model adapted for processing images. As mentioned above, the ViT-based model may be pre-trained on the large ImageNet-1K dataset [46].

The ViT-based model may be selected to be a ViT(T) model as defined in [49], a ViT(S) model as defined in [50], etc. Preferably, the ViT-based model is selected to be the ViT(S) model.

In the step 730, advantageously, the plurality of clients performs a CWT FL process 800 to update respective local ML models of the plurality of clients according to instant pluralities of training data respectively owned by different clients in the plurality of clients while preserving training-data privacy among the different clients. As used herein, “an instant plurality of training data” is a plurality of training data available at the time when the plurality of training data is actually processed in the CWT FL process 800. That is, the aforementioned plurality of training data may be time-varying and may contain different sets of training data at different time instants. The updating of the respective local ML models is realized by fine-tuning these local ML models using self-constructed anti-counterfeiting QR code datasets respectively generated by the plurality of clients, allowing model parameters of these local ML models to adapt to specific characteristics of anti-counterfeiting QR codes encountered by the plurality of clients.

Usually in practice, an instant plurality of training data owned by a client is generated according to information obtained by the client in multiple executions of the step 720. In certain embodiments, a corresponding instant plurality of training data owned by the individual client is generated according to authentication results obtained form using the local ML model of the individual client to authenticate QR-code images received by the individual client.

As a result of using the authentication results generated by the individual client in the step 720 to produce the corresponding instant plurality of training data owned by the individual client, the step 720 is generally considered to precede the step 730. In addition, the instant plurality of training data is privately owned by the client and is not shared with other clients in the plurality of clients.

In practical realization of the disclosed method, it is often that the local ML model of the individual client is continually updated over time with newly-emerged training data. In certain embodiments, the step 730 is repeated from time to time for regularly updating respective local ML models of the plurality of clients. The local ML model is regularly updated in the sense that the local ML model is repeatedly updated from time to time.

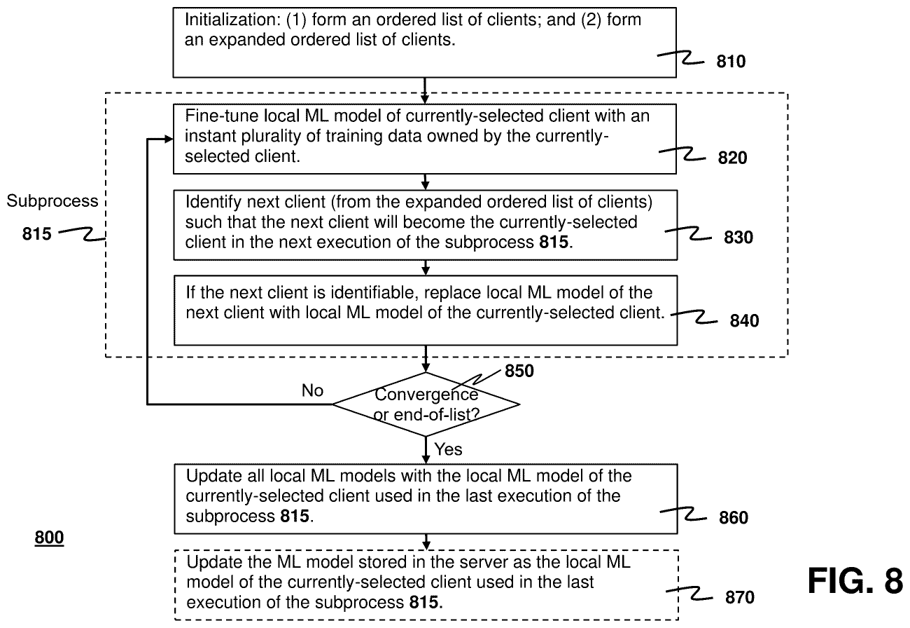

FIG. 8 depicts a flowchart for realizing certain embodiments of the CWT FL process 800.

The CWT FL process 800 begins with an initialization step 810. In the initialization step 810, the plurality of clients is ordered to yield an ordered list of clients, and an expanded ordered list of clients is formed by repeating the ordered list of clients for a predetermined number of times. Refer to Algorithm 1. The ordered list of clients specifies the order of clients used in a single communication round for sequentially fine-tuning the respective local ML models such that the respective local ML models are progressively updated. The predetermined number of times is the number of communication rounds, R, used in cyclically updating the respective local ML models. The expanded ordered list of clients specifies the order of clients used in the sequential fine-tuning of the respective local ML models over the R communication rounds.

After the initialization step 810 is performed, a subprocess 815 of fine-tuning the local ML model of a currently-selected client is repeated until a stopping condition 850 is met. In certain embodiments, the stopping condition 850 is that all clients sequentially listed in the expanded ordered list of clients have been processed by the subprocess 815. In certain other embodiments, the stopping condition 850 is that at least one of the following conditions is satisfied: a predetermined convergence condition of the respective local ML models of the plurality of clients is met; and respective clients sequentially arranged according to the expanded ordered list of clients have been used as the currently-selected client in running the subprocess 815.

The subprocess 815 includes steps 820, 830 and 840. The currently-selected client in a current execution of the subprocess is identifiable from the expanded ordered list of clients.

In the step 820, the local ML model of the currently-selected client is fine-tuned with a corresponding instant plurality of training data owned by the currently-selected client.

In the step 830, a next client is identified from the expanded ordered list of clients such that the next client becomes the currently-selected client in a next execution of the subprocess. The next execution is immediately next to the current execution. Note that in the special case that the currently-selected client is already the last client in the expanded ordered list of clients, the next client is not identifiable.

The step 840 is performed if the next client is identifiable. After the local ML model of the currently-selected client is fine-tuned in the step 820, the local ML model of the next client is replaced with the local ML model of the currently-selected client in the step 840. As a result, the corresponding instant plurality of training data owned by the currently-selected client is utilized to update the local ML model of the next client but is not revealed to the next client.

After the subprocess 815 is completed, the respective local ML models of the plurality of clients are updated in step 860 with the local ML model of the currently-selected client used in a last execution of the subprocess 815.

Usually, the ML model, which is copied to the individual client to form the local ML model in the initialization step 710, is stored in a server that serves the plurality of clients. In some practical situations, it is preferable to also update the ML model with the local ML model of the currently-selected client used in the last execution of the subprocess 815 such that the server is allowed to initialize a new local ML model of a new client with the updated ML model when the server adds the new client to the plurality of clients. In certain embodiments of the CWT FL process 800, step 870 is used for updating the ML model with the local ML model of the currently-selected client in the last execution of the subprocess 815.

Other implementation details of the disclosed method are elaborated as follows.

Consider a practical situation that the ML model includes first and second pluralities of model parameters for configuring the ML model, causing the local ML model of the individual client to be configured by corresponding first and second pluralities of model parameters of the individual client. In this situation, the corresponding first plurality of model parameters of the individual client is fixed during executing the CWT FL process 800 while the corresponding second plurality of model parameters of the individual client is adjustable for fine-tuning the local ML model of the individual client in the CWT FL process 800. Operating the ML model with the first and second pluralities of model parameters simplifies the procedure of replacing the local ML model of the next client with the local ML model of the currently-selected client in executing the step 840.

In certain embodiments of the step 840, if the next client is identifiable, the corresponding second plurality of model parameters in the local ML model of the next client is overwritten with the corresponding second plurality of model parameters in the local ML model of the currently-selected client so as to replace the local ML model of the next client with the local ML model of the currently-selected client.

In one setting of the first and second pluralities of model parameters as mentioned above, the first plurality of model parameters configures the ML model to identify edges and shapes of the anti-counterfeiting QR code. In this setting, the second plurality of model parameters is adjustable and trainable for adapting to a task of determining authenticity of the anti-counterfeiting QR code based on the identified edges and shapes.

The present disclosure may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### REFERENCES

There follows a list of references that are occasionally cited in the specification. Each of the disclosures of these references is incorporated by reference herein in its entirety.
[1]J. Zhang, Z. Wang, X. Huo, X. Meng, Y. Wang, H. Suo, and P. Li, “Anti-counterfeiting application of persistent luminescence materials and its research progress,” Laser & Photonics Reviews, vol. 18, no. 3, p. 2300751, 2024.
[2]Y. Yan, Z. Zou, H. Xie, Y. Gao, and L. Zheng, “An IoT based anti-counterfeiting system using visual features on qr code,” IEEE Internet of Things Journal, vol. 8, no. 8,pp. 6789-6799, 2020.
[3]J. Picard, P. Landry, and M. Bolay, “Counterfeit detection with QR codes,” in Proceedings of the 21stACM Symposium on Document Engineering, pp. 1-4, 2021.
[4]J.-S. Pan, X.-X. Sun, S.-C. Chu, A. Abraham, and B. Yan, “Digital watermarking with improved SMS applied for QR code,” Engineering Applications of Artificial Intelligence, vol. 97, p. 104049, 2021.
[5]Y.-M. Wang, C.-T. Sun, P.-C. Kuan, C.-S. Lu, and H.-C. Wang, “Secured graphic QR code with infrared watermark,” in Proceeding of 2018 IEEE International Conference on Applied System Invention (ICASI), pp. 690-693, IEEE, 2018.
[6]M. K. Harahap and N. Khairina, “Copyright protection of scientific works using digital watermarking by embedding DOI QR code,” Journal of Computer Networks, Architecture and High Performance Computing, vol. 3, no. 2, pp. 234-240, 2021.
[7]J. Liu, J. Han, K. Fu, J. Jia, D. Zhu, and G. Zhai, “Application of QR code watermarking and encryption in the protection of data privacy of intelligent mouth-opening trainer,” IEEE Internet of Things Journal, vol. 10, no. 12, pp. 10510-10518, 2023.
[8]C. Shaik, “Preventing counterfeit products using cryptography, QR code and webservice,” Computer Science & Engineering: An International Journal (CSEIJ), vol. 11, no. 1, 2021.
[9]H. R. H. Al Dallal and W. N. M. Al Mukhtar, “A QR code used for personal information based on multilayer encryption system,” Int. J. Interact. Mob. Technol., vol. 17, no. 9, pp. 44-56, 2023.
[10]A. Fernández-Benito, M. Hoyos, M. A. López-Manchado, and T. J. Sorensen, “A physical unclonable function based on recyclable polymer nanoparticles to enable the circular economy,” ACS Applied Nano Materials, vol. 5, no. 10, pp. 13752-13760, 2022.
[11]H. Im, J. Yoon, J. Choi, J. Kim, S. Baek, D. H. Park, W. Park, and S. Kim, “Chaotic organic crystal phosphorescent patterns for physical unclonable functions,” Advanced Materials, vol. 33, no. 44, p. 2102542, 2021.
[12]V. Lapidas, A. Zhizhchenko, E. Pustovalov, D. Storozhenko, and A. Kuchmizhak, “Direct laser printing of high-resolution physically unclonable function anti-counterfeit labels,” Applied Physics Letters, vol. 120, no. 26, 2022.
[13]R. Chaban, O. Taran, J. Tutt, Y. Belousov, B. Pulfer, T. Holotyak, and S. Voloshynovskiy, “Printing variability of copy detection patterns,” in Proceedings of 2022 IEEE International Workshop on Information Forensics and Security (WIFS), pp. 1-6, IEEE, 2022.
[14]O. Taran, J. Tutt, T. Holotyak, R. Chaban, S. Bonev, and S. Voloshynovskiy, “Mobile authentication of copy detection patterns,” EURASIP Journal on Information Security, vol. 2023, no. 1, p. 4, 2023.
[15]Z. Zheng, H. Zheng, J. Ju, D. Chen, X. Li, Z. Guo, C. You, and M. Lin, “A system for identifying an anticounterfeiting pattern based on the statistical difference in key image regions,” Expert Systems with Applications, vol. 183, p. 115410, 2021.
[16]Z. Zheng, B. Xu, J. Ju, Z. Guo, C. You, Q. Lei, and Q. Zhang, “Circumferential local ternary pattern: New and efficient feature descriptors for anti-counterfeiting pattern identification,” IEEE Transactions on Information Forensics and Security, vol. 17, pp. 970-981, 2022.
[17]C. You, H. Zheng, Z. Guo, T. Wang, J. Ju, and X. Li, “Identification of a printed anti-counterfeiting code based on feature guidance double pool attention networks,” Computers, Materials & Continua, vol. 75, no. 2, 2023.
[18]H. Zheng, C. Zhou, X. Li, T. Wang, and C. You, “Forgery detection for anti-counterfeiting patterns using deep single classifier,” Applied Sciences, vol. 13, no. 14, p. 8101, 2023.
[19]T. Wang, H. Zheng, C. You, and J. Ju, “A texture-hidden anti-counterfeiting qr code and authentication method,” Sensors, vol. 23, no. 2, p. 795, 2023.
[20]C. Chen, M. Li, A. Ferreira, J. Huang, and R. Cai, “A copy-proof scheme based on the spectral and spatial barcoding channel models,” IEEE Transactions on Information Forensics and Security, vol. 15, pp. 1056-1071, 2019.
[21]T. Wang, H. Zheng, Z. Guo, C. You, and J. Ju, “Anti-counterfeiting textured pattern,” Visual Computer, vol. 40, no. 3, p. 2139-2160, 2023.
[22]Z. Guo, H. Zheng, C. You, T. Wang, and C. Liu, “DMF-Net: Dual-branch multi-scale feature fusion network for copy forgery identification of anti-counterfeiting QR code,” arXiv preprint arXiv:2201.07583, 2022.
[23]Z. Guo, S. Wang, Z. Zheng, and K. Sun, “Printer source identification of quick response codes using residual attention network and smartphones,” Engineering Applications of Artificial Intelligence, vol. 131, p. 107822, 2024.
[24]F. Z. Mehrjardi, A. M. Latif, M. S. Zarchi, and R. Sheikhpour, “A survey on deep learning-based image forgery detection,” Pattern Recognition, p. 109778, 2023.
[25]S. Lu, Z. Gao, Q. Xu, C. Jiang, A. Zhang, and X. Wang, “Class-imbalance privacy-preserving federated learning for decentralized fault diagnosis with biometric authentication,” IEEE Transactions on industrial informatics, vol. 18, no. 12, pp. 9101-9111, 2022.
[26]D. Liu, Z. Dang, C. Peng, Y. Zheng, S. Li, N. Wang, and X. Gao, “Fedforgery: generalized face forgery detection with residual federated learning,” IEEE Transactions on Information Forensics and Security, 2023.
[27]K. Wei, J. Li, M. Ding, C. Ma, H. H. Yang, F. Farokhi, S. Jin, T. Q. Quek, and H. V. Poor, “Federated learning with differential privacy: Algorithms and performance analysis,” IEEE transactions on information forensics and security, vol. 15, pp. 3454-3469, 2020.
[28]L. Qu, Y. Zhou, P. P. Liang, Y. Xia, F. Wang, E. Adeli, L. Fei-Fei, and D. Rubin, “Rethinking architecture design for tackling data heterogeneity in federated learning,” in Proceedings of the IEEE/CVF conference on computer vision and pattern recognition, pp. 10061-10071, 2022.
[29]Y. Bai, J. Mei, A. L. Yuille, and C. Xie, “Are transformers more robust than CNNs?” Advances in neural information processing systems, vol. 34, pp. 26831-26843, 2021.
[30]X. Mao, G. Qi, Y. Chen, X. Li, R. Duan, S. Ye, Y. He, and H. Xue, “Towards robust vision transformer,” in Proceedings of the IEEE/CVF conference on Computer Vision and Pattern Recognition, pp. 12042-12051, 2022.
[31]S. Paul and P.-Y. Chen, “Vision transformers are robust learners,” in Proceedings of the AAAI conference on Artificial Intelligence, vol. 36, pp. 2071-2081, 2022.
[32]D. Zhou, Z. Yu, E. Xie, C. Xiao, A. Anandkumar, J. Feng, and J. M. Alvarez, “Understanding the robustness in vision transformers,” in Proceedings of International Conference on Machine Learning, pp. 27378-27394, PMLR, 2022.
[33]Z. Yin, E. Xing, and Z. Shen, “Squeeze, recover and relabel: Dataset condensation at imagenet scale from a new perspective,” Advances in Neural Information Processing Systems, vol. 36, 2024.
[34]Y. You, Z. Zhang, C.-J. Hsieh, J. Demmel, and K. Keutzer, “Imagenet training in minutes,” in Proceedings of the 47th international conference on parallel processing, pp. 1-10, 2018.
[35]H. P. Nguyen, F. Retraint, F. Morain-Nicolier, and A. Delahaies, “A watermarking technique to secure printed matrix barcode—application for anti-counterfeit packaging,” IEEE Access, vol. 7, pp. 131839-131850, 2019.
[36]N. Xie, J. Chen, Y. Chen, J. Hu, Q. Zhang, C. Chen, and L. Huang, “Detection of information hiding at anticopying 2d barcodes,” IEEE Transactions on Circuits and Systems for Video Technology, vol. 32, no. 1, pp. 437-450, 2021.
[37]J. Chen, L. Dong, R. Wang, D. Yan, and C. Peng, “Mixed-bit sampling graphic: When watermarking meets copy detection pattern,” IEEE Signal Processing Letters, 2023.
[38]C. Vinh Loc, T. Xuan Viet, T. Hoang Viet, L. Hoang Thao, and N. Hoang Viet, “Deep learning based-approach for quick response code verification,” Applied Intelligence, vol. 53, no. 19, pp. 22700-22714, 2023.
[39]A. Vaswani, “Attention is all you need,” arXiv preprint arXiv:1706.03762, 2017.
[40]A. Dosovitskiy et al., “An image is worth 16×16 words: Transformers for image recognition at scale,” arXiv preprint arXiv:2010.11929, 2020.
[41]M. M. Naseer, K. Ranasinghe, S. H. Khan, M. Hayat, F. Shahbaz Khan, and M.-H. Yang, “Intriguing properties of vision transformers,” Advances in Neural Information Processing Systems, vol. 34, pp. 23296-23308, 2021.
[42]J. Konečný, H. B. McMahan, F. X. Yu, P. Richtárik, A. T. Suresh, and D. Bacon, “Federated learning: Strategies for improving communication efficiency,” arXiv preprint arXiv:1610.05492, 2016.
[43]Y. Zhao, M. Li, L. Lai, N. Suda, D. Civin, and V. Chandra, “Federated learning with non-IID data,” arXiv preprint arXiv:1806.00582, 2018.
[44]B. McMahan, E. Moore, D. Ramage, S. Hampson, and B. A. y Arcas, “Communication-efficient learning of deep networks from decentralized data,” in Artificial intelligence and statistics, pp. 1273-1282, PMLR, 2017.
[45]K. Chang, N. Balachandar, C. Lam, D. Yi, J. Brown, A. Beers, B. Rosen, D. L. Rubin, and J. Kalpathy-Cramer, “Distributed deep learning networks among institutions for medical imaging,” Journal of the American Medical Informatics Association, vol. 25, no. 8, pp. 945-954, 2018.
[46]J. Deng, W. Dong, R. Socher, L.-J. Li, K. Li, and L. Fei-Fei, “ImageNet: A large-scale hierarchical image database,” in Proceedings of 2009 IEEE conference on computer vision and pattern recognition, pp. 248-255, IEEE, 2009.
[47]K. He, X. Zhang, S. Ren, and J. Sun, “Deep residual learning for image recognition,” in Proceedings of the IEEE conference on computer vision and pattern recognition, pp. 770-778, 2016.
[48]M. Tan and Q. Le, “EfficientNet: Rethinking model scaling for convolutional neural networks,” in Proceedings of International conference on machine learning, pp. 6105-6114, PMLR, 2019.
[49]A. Steiner, A. Kolesnikov, X. Zhai, R. Wightman, J. Uszkoreit, and L. Beyer, “How to train your ViT?data, augmentation, and regularization in vision transformers,” arXiv preprint arXiv:2106.10270, 2021.
[50]X. Chen, C.-J. Hsieh, and B. Gong, “When vision transformers outperform ResNets without pre-training or strong data augmentations,” arXiv preprint arXiv:2106.01548, 2021.

What is claimed is:

1. A method for authenticating, by an individual client in a plurality of clients, an anti-counterfeiting quick response (QR) code as captured in an image presented to the individual client, the method comprising:
using, by the individual client, a local machine-learning (ML) model of the individual client to determine authenticity of the anti-counterfeiting QR code as captured in the image when the image is presented to the individual client, wherein the local ML model of the individual client is initialized as a local copy of a ML model shared by the plurality of clients, the ML model being a Vision Transformer-based model pretrained for processing an input image to determine authenticity of the anti-counterfeiting QR code as captured in the input image; and
performing, by the plurality of clients, a cyclic weight transfer (CWT) federated learning (FL) process to update respective local ML models of the plurality of clients according to instant pluralities of training data respectively owned by different clients in the plurality of clients while preserving training-data privacy among the different clients.

2. The method of claim 1, wherein the CWT FL process comprises:
ordering the plurality of clients to yield an ordered list of clients;
forming an expanded ordered list of clients by repeating the ordered list of clients for a predetermined number of times;
repeating a subprocess of fine-tuning the local ML model of a currently-selected client until a predetermined convergence condition of respective local ML models of the plurality of clients is met or until respective clients sequentially arranged according to the expanded ordered list of clients have been used as the currently-selected client in running the subprocess, wherein the subprocess comprises:
fine-tuning the local ML model of the currently-selected client with a corresponding instant plurality of training data owned by the currently-selected client;
identifying a next client from the expanded ordered list of clients such that the next client becomes the currently-selected client in a next execution of the subprocess; and
if the next client is identifiable, then after the local ML model of the currently-selected client is fine-tuned, replacing the local ML model of the next client with the local ML model of the currently-selected client such that the corresponding instant plurality of training data owned by the currently-selected client is utilized to update the local ML model of the next client but is not revealed to the next client;
and
updating the respective local ML models of the plurality of clients with the local ML model of the currently-selected client used in a last execution of the subprocess.

3. The method of claim 2, wherein:
the ML model includes first and second pluralities of model parameters for configuring the ML model, causing the local ML model of the individual client to be configured by corresponding first and second pluralities of model parameters of the individual client;
the corresponding first plurality of model parameters of the individual client is fixed during executing the CWT FL process while the corresponding second plurality of model parameters of the individual client is adjustable for fine-tuning the local ML model of the individual client in the CWT FL process; and
the replacing of the local ML model of the next client with the local ML model of the currently-selected client in executing the subprocess includes overwriting the corresponding second plurality of model parameters in the local ML model of the next client with the corresponding second plurality of model parameters in the local ML model of the currently-selected client so as to replace the local ML model of the next client with the local ML model of the currently-selected client.

4. The method of claim 3, wherein the first plurality of model parameters configures the ML model to identify edges and shapes of the anti-counterfeiting QR code.

5. The method of claim 1, wherein a corresponding instant plurality of training data owned by the individual client is generated according to authentication results obtained form using the local ML model of the individual client to authenticate QR-code images received by the individual client.

6. The method of claim 1, wherein the CWT FL process is repeated from time to time for regularly updating the respective local ML models.

7. The method of claim 1, wherein the Vision Transformer-based model is selected to be a ViT(S) model.

8. The method of claim 1, wherein:
the ML model is stored in a server that serves the plurality of clients; and
the CWT FL process further comprises updating the ML model with the local ML model of the currently-selected client used in the last execution of the subprocess to thereby allow the server to initialize a new local ML model of a new client with the updated ML model when the server adds the new client to the plurality of clients.
